(19) United States
(12) Patent Application Publication
(10) Pub. No.: US 2022/0150630 A1
(43) Pub. Date: May 12, 2022

(54) SOUND SYSTEM, SOUND SIGNAL PROCESSING DEVICE, AND SOUND SIGNAL PROCESSING METHOD

(71) Applicant: DENSO TEN Limited, Kobe-shi (JP)

(72) Inventors: Kunihiko IRIE, Kobe-shi (JP); Keiichiro TANAKA, Kobe-shi (JP)

(73) Assignee: DENSO TEN Limited, Kobe-shi (JP)

(21) Appl. No.: 17/228,236

(22) Filed: Apr. 12, 2021

(30) Foreign Application Priority Data
Nov. 6, 2020 (JP) 2020-185502

(51) Int. Cl. H04R 5/04; H04R 5/02; H04S 3/00; H04S 7/00

(52) U.S. Cl. CPC H04R 5/04; H04R 5/02; H04S 2400/01; H04S 7/30; H04S 3/008

(57) ABSTRACT

A sound system that processes multichannel sound signals to output sound from a plurality of speakers includes: a sound appliance; and a sound signal processing device provided communicably with the sound appliance and configured to receive the multichannel sound signals from the sound appliance. The sound signal processing device outputs part of the received multichannel sound signals to a first speaker constituting part of the plurality of speakers, and returns another part of the received multichannel sound signals to the sound appliance. The sound appliance outputs the another part of the sound signals returned from the sound signal processing device to a second speaker constituting another part of the plurality of speakers.

This application is based on Japanese Patent Application No. 2020-185502 filed on Nov. 6, 2020, the contents of which are hereby incorporated by reference.

### BACKGROUND OF THE INVENTION

### 1. Field of the Invention

The present invention relates to a sound system, a sound signal processing device, and a sound signal processing method.

### 2. Description of Related Art

Technologies are known whereby an additional unit (additional processing device) is connected to a digital sound signal processing device with the aim of adding a digital signal processing function (see, for example, JP-A-H05-103399). The additional unit is an external unit that is detachably attached to the main unit of the digital sound signal processing device. Sound signals are output to speakers from only one of the device's main unit and the external unit.

### SUMMARY OF THE INVENTION

Conventionally, upgrading of a sound appliance to a superior sound system is achieved by providing an external unit with an amplifier function compatible with multiple channels and yielding outputs to speakers from the external unit. In this case, no effective use is made of the amplifier function provided in the sound appliance. This leaves room for improvement

In view of the inconvenience mentioned above, an object of the present invention is to provide a technology that helps obtain a high-performance multichannel sound system while keeping down costs.

To achieve the above object, according to one aspect of the present invention, a sound system configured to process multichannel sound signals to output sound from a plurality of speakers includes: a sound appliance; and a sound signal processing device provided communicably with the sound appliance and configured to receive the multichannel sound signals from the sound appliance. The sound signal processing device is configured to output part of the received multichannel sound signals to a first speaker constituting part of the plurality of speakers and return another part of the received multichannel sound signals to the sound appliance. The sound appliance outputs the another part of the sound signals returned from the sound signal processing device to a second speaker constituting another part of the plurality of speakers.

To achieve the above object, according to another aspect of the present invention, a sound signal processing device configured to receive multichannel sound signals from a sound appliance is configured to output part of the received multichannel sound signals to a speaker and return another part of the received multichannel sound signals to the sound appliance.

To achieve the above object, according to yet another aspect of the present invention, a method of signal processing in a device configured to receive multichannel sound signals from a sound appliance includes: outputting part of the multichannel sound signals received from the sound appliance to a speaker; and returning another part of the multichannel sound signals to the sound appliance.

### BRIEF DESCRIPTION OF THE DRAWINGS

FIG. 1 is a block diagram showing the configuration of a sound system;

FIG. 2A is a functional block diagram showing the sound processing functions of a first signal processor;

FIG. 2B is a functional block diagram showing the sound processing function of a second signal processor;

FIG. 3 is a flow chart showing an example of signal processing in the sound system;

FIG. 4 is a flow chart showing a modified example of signal processing in the sound system; and

FIG. 5 is a block diagram showing the configuration of a modified example of the sound system.

### DETAILED DESCRIPTION OF PREFERRED EMBODIMENTS

An illustrative embodiment of the present invention will be described in detail below with reference to the accompanying drawings.

1. Outline of Sound system

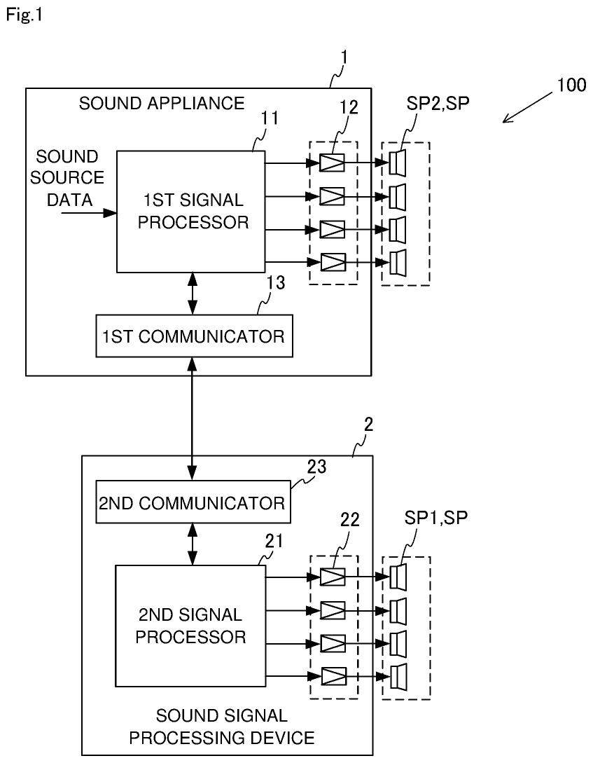

FIG. 1 is a block diagram showing the configuration of a sound system 100 according to an embodiment of the present invention. The sound system 100 is a system that processes multichannel sound signals to output sound from a plurality of speakers SP. The sound system 100 according to the embodiment can process eight-channel sound signals to output sound from eight speakers SP. The number of channels (ch) that the sound system 100 can deal with can be modified as necessary.

The sound system 100 is mounted, for example, on a vehicle such as an automobile. The sound system 100 does not necessarily have to be mounted on a vehicle, but may instead be installed on any mobile body other than a vehicle, such as an aircraft or a vessel, or elsewhere than on a mobile body, such as inside a room in a building. As shown in FIG. 1, the sound system 100 includes a sound appliance 1 and a sound signal processing device 2. The sound system 100 may or may not include a speaker SP. In the embodiment, the speaker SP is composed of a first speaker SP1 connected to the sound signal processing device 2 and a second speaker SP2 connected to the sound appliance 1.

The sound appliance 1 in the embodiment has a function of reproducing sound. The sound appliance 1 reproduces sound by reading sound information from a recording medium such as an optical disc or a USB memory. Or the sound appliance 1 reproduces sound by receiving sound information from an external device on a wired or wireless basis. The sound appliance 1 may have, in addition to the function of reproducing sound, a function of generating sound and a function of recording sound. The sound appliance 1 may be, for example, a vehicle-mounted audio appliance. The sound appliance 1 may be a multifunction device provided with functions as a sound appliance as well as other functions, such as a navigation device, a display-audio device, or a smart speaker. That is, the sound appliance 1 may have a voice guidance function, a hands-free telephone conversation function, a voice assistant function, or the like.

The sound signal processing device 2 is an external unit that is externally connected to the sound appliance 1. The sound signal processing device 2 is provided so as to be able to communicate with the sound appliance 1. Specifically, the sound signal processing device 2 is connected to the sound appliance 1 so that they can conduct digital communication with each other. The sound signal processing device 2 receives multichannel sound signals from the sound appliance 1. The sound signal processing device 2 subjects the received sound signals to various kinds of processing. The processing may include sound-field control, frequency characteristics control, and the like. In the embodiment, the sound signal processing device 2 is configured to be capable of receiving eight-channel sound signals and performing sound processing on eight-channel sound signals.

Different configurations can be used as follows: Luxury-grade vehicles can be furnished with the sound system 100 according to the embodiment; popular-grade vehicles can be furnished with the sound system 100 according to the embodiment minus the sound signal processing device 2.

2. Configuration of Sound appliance

As shown in FIG. 1, the sound appliance 1 includes a first signal processor 11, a first amplifier 12, and a first communicator 13.

The first signal processor 11 includes a signal processing circuit that performs various kinds of signal processing related to sound, and is configured as, for example, a DSP (digital signal processor). In the embodiment, the first signal processor 11 is controlled by a controller (not shown) provided in the sound appliance 1. The first signal processor 11 receives sound source data in the form of a digital signal. In the embodiment, the sound source data includes reproduced sound data reproduced by a reproduction processor (not shown) in the sound appliance 1, generated sound data generated by a sound generation processor (not shown), telephone conversation data from hands-free telephone conversation, and the like. Reproduced sound data is, for example, eight-channel sound signals. Generated sound data includes, for example, an audio signal for voice guidance, an audio signal of uttered voice for a voice assistant function.

The first amplifier 12 amplifies the sound signals output from the first signal processor 11 and then analog-converted by a digital-to-analog conversion circuit (not shown), and outputs the results to the second speaker SP2. In the embodiment, the sound appliance 1 includes four first amplifiers 12. Each of the first amplifiers 12 outputs a sound signal to the second speaker SP2 associated with it. Thus, in the embodiment, four second speakers PS2 are provided.

The first communicator 13 transmits information to the sound signal processing device 2, and receives information from the sound signal processing device 2. The first communicator 13 exchanges signals with the sound signal processing device 2 by digital communication. The digital communication here can comply with any standard, examples including, but not limited to, SPI (serial peripheral interface), I2C (inter-integrated circuit), and IEEE1394.

3. Configuration of Sound Signal Processing Device

As shown in FIG. 1, the sound signal processing device 2 includes a second signal processor 21, a second amplifier 22, and a second communicator 23.

The second signal processor 21 includes a signal processing circuit that performs various kinds of signal processing on the sound signal transmitted from the sound appliance 1, and is configured as, for example, a DSP. The second signal processor 21 may have a sound processing function that overlaps with a function of the first signal processor 11 provided in the sound appliance 1. However, in the embodiment, the second signal processor 21 is configured to have a sound processing function different from any function of the first signal processor 11. This will now be described.

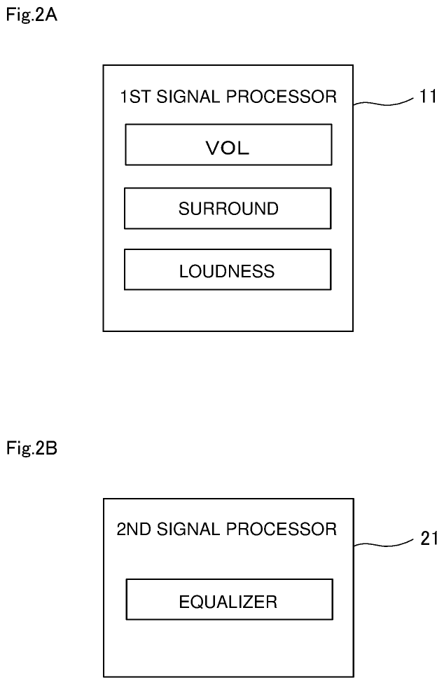

FIG. 2A is a functional block diagram showing the sound processing functions of the first signal processor 11. FIG. 2B is a functional block diagram showing the sound processing function of the second signal processor 21. As shown in FIG. 2A, the first signal processor 11 has a VOL function for controlling the sound volume of the sound signal, a surround function for controlling the surround characteristics of the sound signal, and a loudness function for controlling the loudness of the sound signal. As shown in FIG. 2B, the second signal processor 21 has an equalizer function for controlling equalization for the sound signal.

As shown in FIGS. 2A and 2B, in the embodiment, the sound processing on the multichannel sound signals includes four kinds of processing, namely volume control, surround control, loudness control, and equalization control. Of the four kinds of sound processing, three are performed in the first signal processor 11 (sound appliance 1), and the rest, one, is performed in the second signal processor 21 (sound signal processing device 2). The multichannel sound signals may be subjected to any number, other than four, of kinds of sound processing. The number of kinds and the kinds of sound processing that are performed in each of the sound appliance 1 and the sound signal processing device 2 may be modified from those in the embodiment.

As described above, the processing performed on the multichannel sound signals preferably includes a plurality of kinds of sound processing. Preferably, part of the plurality of kinds of sound processing are performed in the sound appliance 1 and at least part of the rest are performed in the sound signal processing device 2. This configuration helps avoid an overlap of functions between the sound appliance 1 and the sound signal processing device 2, and thus helps suppress extra costs. A configuration where the sound appliance 1 performs those kinds of sound processing which are common to popular-grade and luxury-grade vehicles helps minimize the functions that have to be covered by the sound signal processing device 2, which is additionally fitted to luxury-grades. As the case may be, a configuration is also possible where all of the plurality of kinds of sound processing are performed in the sound signal processing device 2.

The second amplifier 22 amplifies the sound signals output from the second signal processor 21 and then analog-converted by a digital-to-analog conversion circuit (not shown), and outputs the results to the first speaker SP1. In the embodiment, the sound signal processing device 2 includes four second amplifiers 22. Each of the second amplifiers 22 outputs a sound signal to the first speaker SP1 with which it is associated. That is, in the embodiment, four first speakers SP1 are provided.

The second communicator 23 transmits information to the sound appliance 1, and receives information from the sound appliance 1. The second communicator 23 exchanges signals with the sound appliance 1 by digital communication. The digital communication here can comply with the same standard as in the first communicator 13, examples including SPI.

4. Signal Processing

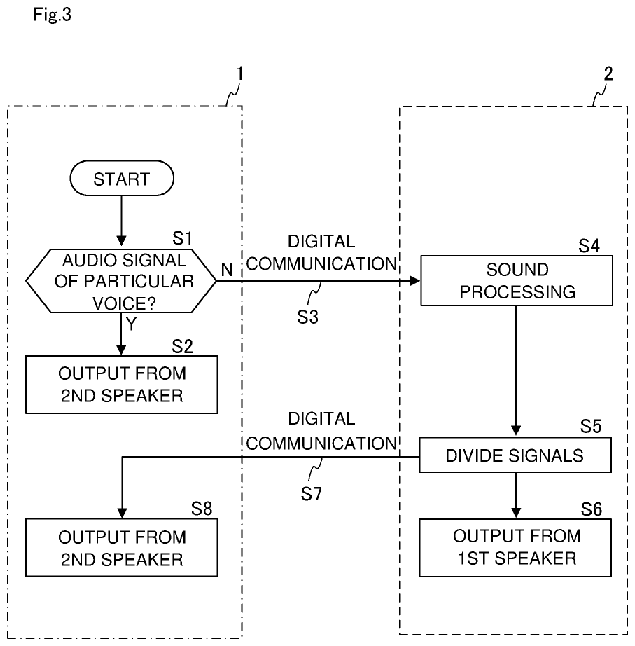

Next, an example of signal processing in the sound system 100 composed of the sound appliance 1 and the sound signal processing device 2 will be described. FIG. 3 is a flow chart showing an example of signal processing in the sound system 100. In FIG. 3, a dash-and-dot line surrounds the operation of the sound appliance 1, and a broken-line surrounds the operation of the sound signal processing device 2. When the first signal processor 11 receives sound source data (a digital signal), the procedure shown in FIG. 3 starts.

At step S1, the first signal processor 11 in the sound appliance 1 checks whether the received sound source data is an audio signal of particular voice. Particular voice refers to voice that the sound appliance 1 uses to perform a particular function (such voice will hereinafter be referred to as “functional voice”). A particular function is, preferably, a function of outputting voice in the form of a dialogue. Functional voice (particular voice) preferably includes at least one of voice for voice guidance, voice for hands-free telephone conversation, and uttered voice for a voice assistance function. This configuration enables output of functional voice at appropriate times while distinguishing such voice for which timing counts from other voice. The first signal processor 11 checks whether given voice is functional voice according to information (signal) transmitted from a controller (not shown) that controls the first signal processor 11.

If the received sound source data is a particular audio signal (step S1, “Yes”), the procedure proceeds to step S2. If the received sound source data is not a particular audio signal (step S1, “No”), the procedure proceeds to step S3. As the procedure proceeds to step S2 or S3, the first signal processor 11 subject the received signal to signal processing as necessary. For example, the first signal processor 11 subjects the multichannel sound signals to volume control, surround control, and loudness control as mentioned above.

At step S2, the first signal processor 11 in the sound appliance 1 so operates that functional voice is output from the second speaker SP2. Specifically, the first signal processor 11 outputs to the first amplifier 12 an audio signal of functional voice that has undergone predetermined processing. Thus, the second speaker SP2 delivers the functional voice. The functional voice is output, for example, from one second speaker SP2. The functional voice may instead be output from a plurality of second speakers SP2.

Thus, the sound appliance 1 outputs an audio signal of particular voice (functional voice) to the second speaker SP2 without letting it pass through the sound signal processing device 2. It is thus possible to output functional voice directly from a speaker SP with no detour via the sound signal processing device 2, and this helps reduce the time required to output functional voice. Considering, in particular, that the sound signal processing device 2 is required to be capable of complicate processing and tends to take time to perform it, the configuration of the embodiment, where functional voice is processed separately from other voice, is beneficial.

At step S3, the first communicator 13 in the sound appliance 1 transmits to the sound signal processing device 2 the multichannel (in the embodiment, eight-channel) sound signals having undergone predetermined processing. Thus, the second communicator 23 in the sound signal processing device 2 receives the multichannel sound signals, and the received sound signals are fed to the second signal processor 21 in the sound signal processing device 2. When the operation at step S3 is complete, the procedure proceeds to step S4.

At step S4, the second signal processor 21 in the sound signal processing device 2 subjects the received multichannel sound signals to sound processing. In the embodiment, the sound processing performed in the second signal processor 21 is equalization control. When the sound processing is complete, the procedure proceeds to the next step, S5.

At step S5, the second signal processor 21 divides the multichannel sound signals having undergone sound processing into two groups. In the embodiment, the second signal processor 21 divides the eight-channel sound signals into two groups each including four-channel sound signals. The two groups may include different numbers of channels of sound signals. In that case, however, the sound appliance 1 and the sound signal processing device 2 have to have modified amplifier configurations. When the operation at step S5 is complete, the procedure proceeds to steps S6 and S7.

At step S6, the second signal processor 21 so operates as to output from the first speaker SP1 the sound signals (four-channel sound signals) of one of the two groups. This operation includes adjustment for reducing a lag in the timing of output of the sound signals between the two groups. After the adjustment, the second signal processor 21 outputs four-channel sound signals to the four second amplifiers 22. Thus, the four first speakers SP1 deliver sound.

At step S7, the second communicator 23 in the sound signal processing device 2 transmits the four-channel sound signals having undergone sound processing to the sound appliance 1. The transmitted four-channel sound signals are received by the first communicator 13, and are fed to the first signal processor 11. When the operation at step S7 is complete, the procedure proceeds to step S8.

At step S8, the first signal processor 11 in the sound appliance 1 so operates as to output from the second speaker SP2 the four-channel sound signals that have been returned from the sound signal processing device 2. Specifically, the first signal processor 11 processes the returned four-channel sound signals as necessary, and then outputs them to the first amplifier 12. Thus, the four second speakers SP2 deliver sound. Since, as mentioned above, timing adjustment has been done so that the first and second speakers SP1 and SP2 yield output simultaneously, the eight-channel sound signals let the eight speakers deliver sound with adjusted timing.

As described above, the sound signal processing device 2 outputs part of the received multichannel sound signals to first speakers SP1 constituting part of a plurality of speakers SP, and returns another part of the received multichannel sound signals to the sound appliance 1. Then the sound appliance 1 outputs the another part of the sound signals returned from the sound signal processing device 2 to second speakers SP2 constituting another part of the plurality of speakers SP.

With this configuration, it is possible to add the sound signal processing device 2 to the sound appliance 1 while utilizing the amplifier function provided in the sound appliance 1. It is thus possible to obtain a high-performance multichannel sound system with suppressed additional costs. It is possible, in luxury-grade vehicles, to make effective use of a sound system that is mounted on popular-grade vehicles, and thereby to obtain a high-performance multichannel sound system with low additional costs. Compared with a case where a high-performance multichannel sound system is attempted without utilizing the amplifier function provided in the sound appliance 1, it is possible to reduce the share of the amplifier function to be provided in the sound signal processing device 2. It is thus possible to reduce the weight and size of the heat-sink mechanism that is needed to suppress heat generation in the sound signal processing device 2.

Moreover, in the embodiment, functional voice is output directly from the second speaker SP2 with no detour via the sound signal processing device 2. Thus, in the sound system 100, when only functional voice needs to be output, the sound signal processing device 2 can be left in a standby state, i.e., in an inoperative state. This helps reduce current consumption by the sound system 100.

In the embodiment, another part of the multichannel sound signals are all the rest of the multichannel sound signals except part of them. This, however, does not necessarily have to be so, and a few such examples will be described later.

In the embodiment, when functional voice is output, no other sound is output from the speaker SP. Instead, when functional voice is output, any other sound may be output from the speaker SP. In that case, functional voice may be mixed, in the first signal processor 11, with a sound signal returned from the sound signal processing device 2. As the sound signal returned to the sound appliance 1 to be output from the second speaker SP2, a signal returned from the sound signal processing device 2 to the sound appliance 1 for voice recognition may be used. For example, when voice uttered by a user is subjected to voice recognition, to cancel the sound of music that may mix in the uttered voice, a sound signal is returned from the sound signal processing device 2. As the sound signal output from the second speaker SP2, this returned sound signal may be used.

5. Modified Examples

5-1. First Modified Example

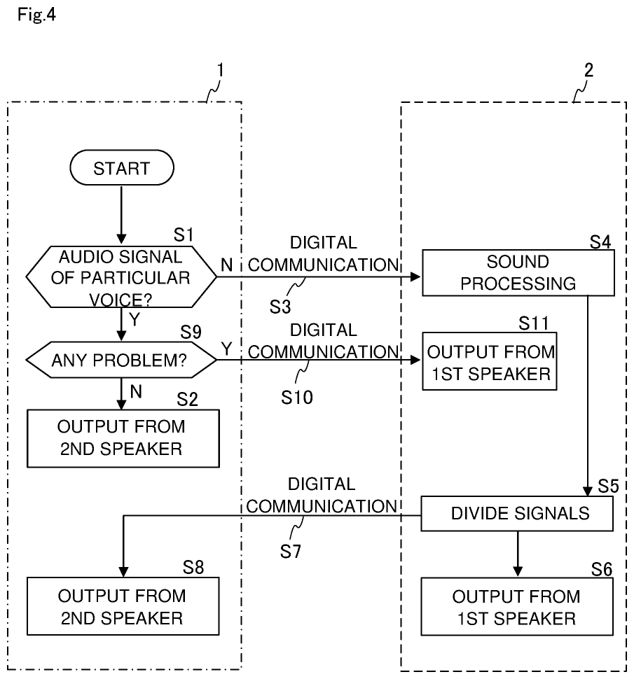

FIG. 4 is a flow chart showing a modified example of signal processing in the sound system 100. In FIG. 4, the operation at steps S1 to S8 is the same as that described above with reference to FIG. 3, and therefore no overlapping description will be repeated.

In this modified example, when step S1 results in “Yes”, instead of the operation at step S2 being performed immediately, the operation at step S9 is performed. At step S9, the first signal processor 11 in the sound appliance 1 checks whether there is any problem in outputting functional voice from the second speaker SP2. A problem can be, for example, a fault in the first amplifier 12 or the like. If there is no problem (step S9, “No”), the procedure proceeds to step S2, so that the second speaker SP2 delivers the functional voice. If there is a problem (step S9, “Yes”), the procedure proceeds to step S10.

At step S10, the first communicator 13 in the sound appliance 1 transmits to the sound signal processing device 2 a predetermined signal indicating that there is a problem along with a sound signal of the functional voice. The signals so transmitted from the first communicator 13 are received by the second communicator 23 in the sound signal processing device 2, and are fed to the second signal processor 21. When the operation at step S10 is complete, the procedure proceeds to step S11.

At step S11, the second signal processor 21 in the sound signal processing device 2 so operates as to output the functional voice from the first speaker SP1. Specifically, the second signal processor 21 outputs the received sound signal of the functional voice to the second amplifier 22. Thus, the first speaker SP1 delivers the functional voice.

As described above, in this modified example, the sound signal processing device 2, on receiving a predetermined notification from the sound appliance 1, outputs a sound signal of particular voice (e.g., functional voice) to the first speaker SP1. With this configuration, it is possible, even when there is a fault in the sound appliance 1, to output particular voice.

In the configuration described above, in a normal state, particular voice (e.g., functional voice) is output from the second speaker SP2 by use of the first amplifier 12 in the sound appliance 1. Only in an abnormal state (e.g., when there is a fault) is particular voice output from the first speaker SP1 by use of the second amplifier 22 in the sound signal processing device 2. This configuration, however, is merely illustrative. A configuration is also possible where, in a normal state, particular voice is output from the first speaker SP1 by use of the second amplifier 22 in the sound signal processing device 2. In that case, a configuration is possible where the sound appliance 1, when unable to communicate with the sound signal processing device 2, outputs a sound signal of particular voice to the second speaker SP2. In this way, even when there is a fault in the sound signal processing device 2, it is possible to output particular voice.

5-2. Second Modified Example

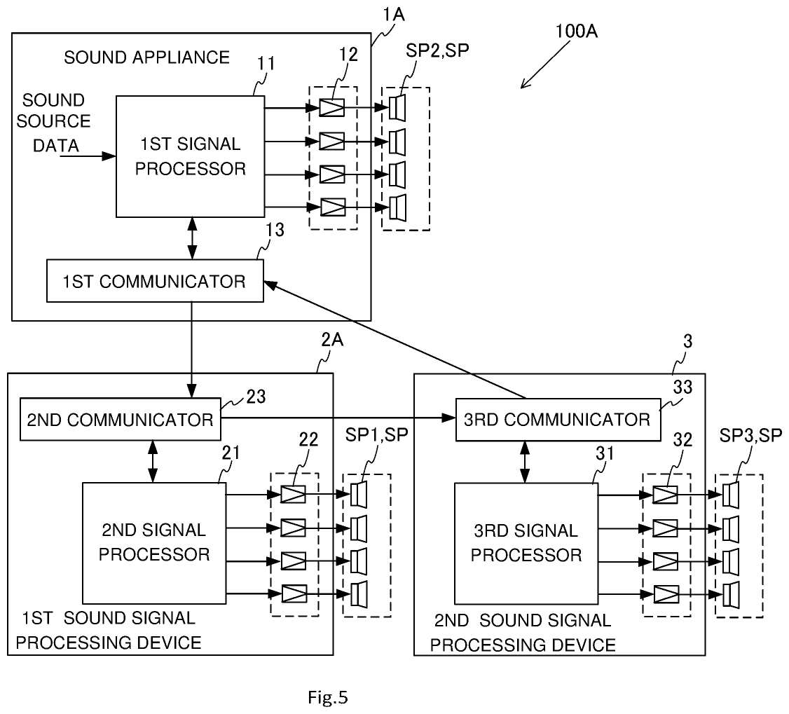

FIG. 5 is a block diagram showing the configuration of another modified example of the sound system 100. The sound system 100 of this modified example includes a sound appliance 1A, a first sound signal processing device 2A, and a second sound signal processing device 3. The sound appliance 1A is configured similarly to that of the sound appliance 1 in the embodiment described previously, and the first sound signal processing device 2A is configured similarly to that of the sound signal processing device 2 in the embodiment described previously. Therefore, no description of the configuration of the sound appliance 1A and the first sound signal processing device 2A will be repeated.

In this modified example, the second sound signal processing device 3 is configured similarly to the first sound signal processing device 2A. Specifically, the second sound signal processing device 3 includes a third signal processor 31, a third amplifier 32, and a third communicator 33. The third signal processor 31 is configured to be capable of sound processing. Specifically, the third signal processor 31 is configured to be capable of equalization control. The third amplifier 32 amplifies the sound signals output from the third signal processor 31 and then analog-converted by a digital-to-analog conversion circuit (not shown), and outputs the results to a third speaker SP3. The third communicator 33 transmits information to the sound appliance 1A, and receives information from the first sound signal processing device 2A.

Also in this modified example, as in the embodiment described previously, multichannel sound signals are fed from the sound appliance 1A to the first sound signal processing device 2A. Here, however, the additional provision of the second sound signal processing device 3 permits twelve-channel sound signals to be received from the sound appliance 1A. The first sound signal processing device 2A, after performing sound processing, outputs from the first speaker SP1 four-channel sound signals which are part of the received twelve-channel sound signals. The first sound signal processing device 2A transmits to the second sound signal processing device 3 another part (all the rest) of the received twelve-channel sound signals. The second sound signal processing device 3 subjects, of the twelve-channel sound signals, the received eight-channel sound signals to sound processing, and then outputs part of them (four-channel) from the third speaker SP3, while transmitting the rest (four-channel) to the sound appliance 1A. The sound appliance 1A outputs the returned sound signals from the second speaker SP2. With this modified example, it is possible to obtain a multichannel sound system that can output twelve-channel sound signals from 12 speakers.

In this modified example, the sound signal processing device 2A outputs part of the multichannel sound signals to the first speaker SP1. The sound signal processing device 2A returns another part of the sound signals via the second sound signal processing device 3 to the sound appliance 1A. With this configuration, it is possible to obtain a high-performance sound system having a plurality of sound signal processing devices added to it as external units.

In this modified example, two sound signal processing devices are provided as external units. There may however be provided three or more such sound signal processing devices. In this modified example, when part of the multichannel sound signals fed to the first sound signal processing device 2A are returned to the sound appliance 1A, they pass through the second sound signal processing device 3. This however is merely illustrative. The part of the multichannel sound signals that are returned from the first sound signal processing device 2A to sound appliance 1A may be returned directly to the sound appliance 1A with no detour via the second sound signal processing device 3.

In this modified example, the first sound signal processing device 2A and the second sound signal processing device 3 are configured similarly. These however may be configured differently. For example, the first sound signal processing device 2A and the second sound signal processing device 3 may handle different numbers of channels or may perform different kinds of processing in their respective signal processors. For another example, the second signal processor 21 in the first sound signal processing device 2A may be configured to perform equalization control and the third signal processor 31 in the second sound signal processing device 3 may be configured to add sound such as engine sound.

6. Notes

The various technical features disclosed herein may be implemented in any other manners than in the embodiments described above, and allow for any modifications made within the spirit of their technical ingenuity. That is, the embodiments described above should be considered to be in every aspect illustrative and not restrictive, and the technical scope of the present invention should be understood to be defined not by the description of the embodiments described above but by the appended claims and to encompass any modifications made in a sense and scope equivalent to the claims. Any two or more of the embodiments and modified examples may be implemented in any viable combinations.

What is claimed is:

1. A sound system configured to process multichannel sound signals to output sound from a plurality of speakers, the sound system comprising:
a sound appliance; and
a sound signal processing device provided communicably with the sound appliance and configured to receive the multichannel sound signals from the sound appliance,
wherein
the sound signal processing device is configured to
output part of the received multichannel sound signals to a first speaker constituting part of the plurality of speakers and
return another part of the received multichannel sound signals to the sound appliance, and
the sound appliance outputs the another part of the sound signals returned from the sound signal processing device to a second speaker constituting another part of the plurality of speakers.

2. The sound system according to claim 1, wherein
the sound appliance outputs a sound signal of particular voice to the second speaker with no detour via the sound signal processing device.

3. The sound system according to claim 2, wherein
on receiving a predetermined notification from the sound appliance, the sound signal processing device outputs the sound signal of the particular voice to the first speaker.

4. The sound system according to claim 1, wherein
when unable to communicate with the sound signal processing device, the sound appliance outputs a sound signal of particular voice to the second speaker.

5. The sound system according to claim 2, wherein
the particular voice includes at least one of voice for voice guidance, voice for hands-free telephone conversation, and uttered voice for a voice assistant function.

6. The sound system according to claim 4, wherein
the particular voice includes at least one of voice for voice guidance, voice for hands-free telephone conversation, and uttered voice for a voice assistant function.

7. The sound system according to claim 1, wherein
the multichannel sound signals are subjected to a plurality of kinds of sound processing, and
part of the plurality of kinds of sound processing are performed in the sound appliance, the rest being performed in the sound signal processing device.

8. The sound system according to claim 1, wherein
the sound signal processing device returns the another part of the sound signals to the sound appliance via another sound signal processing device.

9. A sound signal processing device configured to receive multichannel sound signals from a sound appliance,
wherein the sound signal processing device is configured to
output part of the received multichannel sound signals to a speaker and
return another part of the received multichannel sound signals to the sound appliance.

10. A method of signal processing in a device configured to receive multichannel sound signals from a sound appliance, the method including:
outputting part of the multichannel sound signals received from the sound appliance to a speaker; and
returning another part of the multichannel sound signals to the sound appliance.
